(19) United States
(12) Patent Application Publication
(10) Pub. No.: US 2003/0047177 A1
(43) Pub. Date: Mar. 13, 2003

(54) Method for cutting ingots for use with a wire cutting apparatus

(76) Inventors: Michael Christ, Raleigh, NC (US); Irl E. Ward, Bethlehem, PA (US)

Correspondence Address: JOHN LEZDEY, 1409A NORTH FT HARRISON, CLEARWATER, FL, 33755, US

(21) Appl. No.: 09/950,340

(22) Filed: Sep. 11, 2001

(51) Int. Cl. B28D 1/02; B28D 1/08

(52) U.S. Cl. 125/20; 125/21

(57) ABSTRACT

There is provided a process for significantly reducing thickness variations and the deviations of the wafer's centerline from a reference plane in material cut with wire saws in a wire cutting apparatus by utilizing a sacrificial layer. The sacrificial layer prevents excessive kerf loss in slices or wafers at the wire entry and exit points. The process can be used to produce semiconductor wafers having greater uniformity in thickness.

### BACKGROUND OF THE INVENTION

1. Field of the Invention

This invention relates to a novel cutting method for use with an apparatus for cutting work-pieces of hard and brittle material such as semiconductor ingots of silicon, germanium, gallium arsenide, glass or other brittle materials, such as granite block, into a multiplicity of thin sheets, slices, or wafers.

2. Description of the Prior Art

The cutting apparatus usually comprises a row of fine wires arranged parallel to each other and at fixed pitch. A work-piece is pressed against these fine wires having diameters in the order of 0.15 millimeters running parallel with one another in the same direction, while an abrasive fluid is supplied between the work-piece and the wires, thereby slicing the work-piece into wafers by a grinding action. Thus, the abrasive particles carried by the liquid are transferred to the cutting sections of the wires to produce a splitting or cutting effect. The above described splitting units or machines are described in U.S. Pat. Nos. 3,478,732, 3,525,324, 5,269,275, and 5,270,271, which are incorporated by reference.

The cutting apparatus may also comprise a series of wires inter-looped or entwined together in a braided, linked or beaded loop configuration. This configuration can be used for the cutting of granite block or silicon ingots. The work-piece is pressed against the braided wire and the cutting process is augmented by the abrasive particles as described above.

Achieving an optimum cutting quality depends on a combination of parameters, i.e., the quality of the abrasive fluid, the force with which the work-piece is pressed against the set of cutting wires, the wire tension and speed, the flow of abrsive slurry against the ingot being cut, and the angle of cutting.

Effort is now being directed to optimizing the cutting quality obtained under mass production conditions. By cutting quality is meant exact planarity of the surfaces without taper and thickness variation to yield the sheets or wafers suitable for semiconductor devices and solar cells.

The combination of the abrasive particles and wire motion causes excessive kerf loss at the wire entry and exit points. The excessive kerf loss results in significantly less thickness at the wafer edges than in the central portion of these wafers. The thickness variation is a quality defect and results in yield loss and added processing costs for the wafer manufacturer in subsequent process steps.

U.S. Pat. No. 5,720,271 to Hauser, which is herein incorporated by reference, discloses a process for orienting single crystals for cutting in a cutting machine by use of a cutting support to obtain a predetermined orientation of the single crystal in the cutting machine. A positioning devise is used to obtain exact measurement of the geometric angle of rotation of the crystal. The process requires an acquired skill in the party doing the measurement and orientation. reference, discloses one kind of lubricating and/or cutting composition which can be used in connection with the present invention.

### SUMMARY OF THE INVENTION

According to the present technology there is provided a method for cutting hard and brittle work-pieces in a wire cutting apparatus so as to produce a multiplicity of thin pieces, wafers or slices without excessive kerf loss of the pieces, wafers, or slices at the wire entry and exit points. The improvement is provided by encapsulating the workpiece in an envelope of a sacrificial layer of a material which obtains the initial wire cuts at the entry and exit points at which the excessive kerf normally occurs. The material of the sacrificial layer is one which can be easily removed from the cut pieces, wafers, or slices. Advantageously, the sacrificial layer can be removed by using heat and/or solvents.

The sacrificial layer can be attached directly to the work-piece or through an adhesive layer or it can be one which forms to its own adhesive.

It is, therefore, as a general objective of the invention a method for eliminating excessive kerf loss of slices or wafers prepared from a work-piece cut on a wire cutting apparatus which is utilized in combination with an abrasive slurry.

It is a further object of the invention to provide high quality semiconductor wafers from silicon ingots.

It is another object of the invention to reduce thickness variations in wafers and deviations form the wafer's centerline from a reference point.

It is yet another object of the invention to prevent excessive kerf loss in a wire cutting apparatus used in combination with an abrasive slurry for cutting ingots.

Other objects and advantages of the present invention will become more apparent form the detailed description of the preferred embodiments and with the help of the drawings.

### BRIEF DESCRIPTION OF DRAWINGS

FIG. 1 is a schematic view of a wire cutting apparatus with a silicon ingot encapsulated with a sacrificial material according to the invention.

FIG. 2a illustrates the excessive kerf loss which results in a silicon wafer cut in a cutting apparatus at the wire entry and exit points.

FIG. 2b illustrates the improvement resulting from the cutting of the same ingot of FIG. 2a except with the use of a sacrificial layer according to the invention.

### DESCRIPTION OF THE PREFERRED EMBODIMENTS

According to the present invention, there is provided a means for increasing the efficiency and productivity of abrasion-type splitting units for splitting ingots made of brittle and hard material providing quality components for semiconductors and photocells. The invention provides a method for preparing a work-piece for cutting in an apparatus utilizing an array of wires which are supplied with a slurry of abrasive grains in a dispensing apparatus.

In the prior art, the abrasive slurry and wire motion causes excessive kerf loss at the wire entry and exit points as illustrated in FIG. 2a.

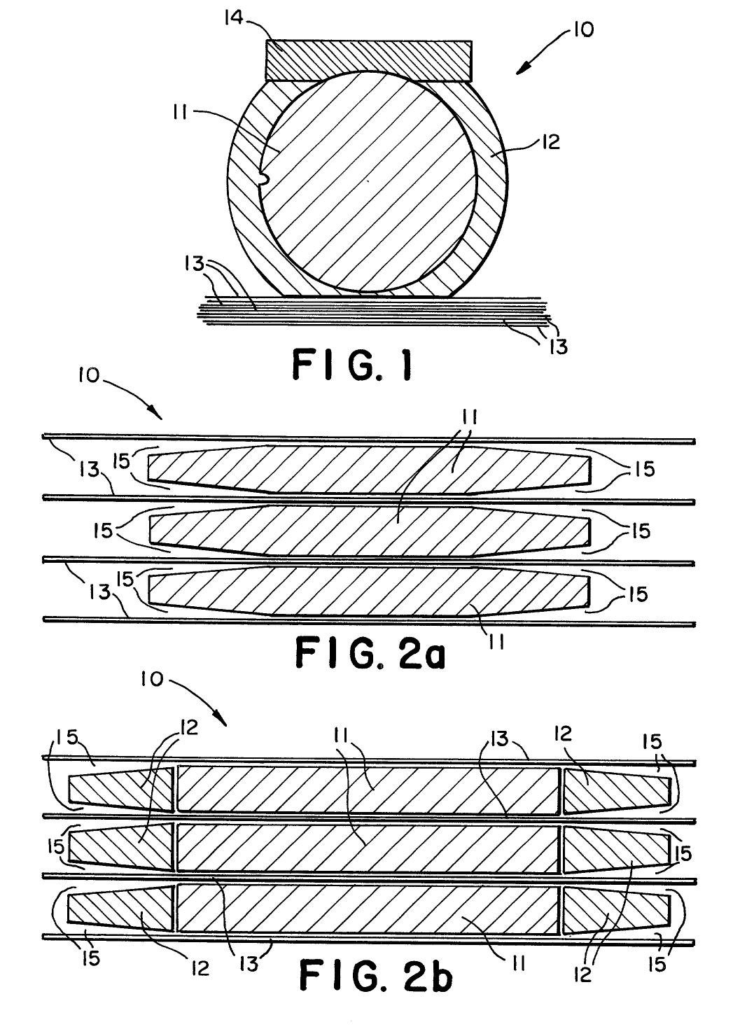

The invention as illustrated in FIG. 1, shows that a cutting apparatus 10, in which a work-piece such as silicon ingots 11, is mounted and contains a sacrificial layer 12 that will be cut by an array of wires.

The silicon ingot 11, which represents the hard and brittle layer work-piece is encapsulated with a sacrificial layer 12. The sacrificial layer is about 0.1 to 3.0 inches in depth. The sacrificial layer 12, can comprise any material which can accept the wire cuts. The sacrificial material may be machined or formed on a mandrel in hemispheres as shown in FIG. 2. The inside diameter of these hemispheres is about 0.1 to 3 millimeters greater than the outside diameter of the work-piece 11, being cut. These hemispheres could be attached to the silicon work-piece 11, by means of the same adhesive used to mount the work-piece 11, to the mounting beam or it can comprise the sacrificial layer. A single hemisphere can also be used.

The sacrificial layer 12, can comprise glass, plastic, epoxy resin, ceramics, polymers and the like. The epoxy resin may be used alone or as the adhesive for the sacrificial layer. If the epoxy itself were used as the sacrificial layer 12, preferably it would be applied in layers, each layer being allowed to cure before adding the next layer. The layering is continued until an envelope of about 0.1 to 3.0 inches in depth is achieved.

Alternatively, the sacrificial material can be machined or formed into tubes and then attached to the work-piece with a suitable material, such as an epoxy resin. Generally, the epoxy resin is one which can be removed from the cut pieces by immersion in water at elevated temperatures, for example, above 60° C.

The adhesive and/or the sacrificial layer should be one which does not soften or dissolve in the lubricating composition used in the cutting apparatus.

As illustrated in FIG. 2b a similar ingot 11, as shown in FIG. 2a which contains a sacrificial layer 12, will show excessive kerf loss primarily in the sacrificial layer 12. The total thickness variation (TTV) of the slice or wafer, namely the difference between the maximum and minimum values of the thickness of the slice or wafer encountered during a scan pattern or a series of point measurement will be of greater uniformity in the products of the process. Polyethylene glycol having a molecular weight of greater than 600 and is solid at ambient temperature, can be used as a sacrificial layer by encapsulating the ingot from a molton or melted ofrm of the polyethylene glycol and forming the solid sacrificial layer by the cooling of the encapsulating molton layer to ambient temperature. It is necessary that the molecular weight of the polyethylene glycol be chosen so that when formed as a sacrificial layer around the ingot, the solid polyethylene glycol does not dissolve or lose its adhesion when in contact with the abrasive slurry during the cutting process. Polyethylene glycols having a molecular weight greater than 1200 are preferred.

A typical lubricating composition, which may be used in the invention especially when an epoxy resin is used as the adhesive or sacrificial material comprises:

a) from about 1 to 55 weight percent of an abrasive suspension agent, and

b) from about 45 to 99 weight percent of a glycol base consisting of a combination of polyalkylene glycols. More specific compositions are disclosed in U.S. Pat. No. 6,054,422 to Ward et al and in U.S. Pat. Nos. 5,349,147 and 5,415,896 which are herein incorporated by reference.

It is understood that the sacrificial layer can be formed on the work-piece itself or separately. The sacrificial layer can be in the form of a tube or sleeve, a single or pair of hemispheres or as a coated layer or cladding. An adhesive layer between the work-piece and the sacrificial layer is utilized when the layer does not adhere to the work-piece and/or cannot be easily removed by use of heat and/or solvent.

The sacrificial material can be made from materials such as glass, plastic, epoxy, polymers, resin, or the like. When preformed, the materials can be adhered to the workpiece with a suitable adhesive which does not dissolve in the lubricating composition utilized. Alternatively, in the case of layers formed form molten liquids of suitable polymers where no other adhesive is utilized, the layer itself must not dissolve or lose adhesion in the lubricating composition utilized.

The process of the invention can be used to prepare thin slices, sheets or wafers of materials such as ingots of silicon, germanium, gallium arsenide, or glass which can be used to form semiconductors, computer chips, magnetic materials, solar energy components and the like.

Examples of suitable plastic materials which can be used as the sacrificial layer can be thermolastic or thermosetting polymers depending upon the work-piece on which they are used. Suitable polymers are the acrylic, phenolic, amino resins, epoxy, polyol, furan polymers, and the like which are disclosed in Modern Plastics Encylopedia 1984-85, which is herein incorporated by reference. The preferred being the epoxies, polyols, and acrylics because of costs and film forming characteristics.

The plastic material may form a matrix with other components forming a material which increase hardness for example, sand, ceramic, and the like, which may be admixed with an acrylic polymer or monomer to form a layer which can be dissolved in a suitable solvent.

Water soluble adhesives may form the adhesive layer or the matrix to form a hardened layer which is later removed in water or organic solvent at an elevated temperature for example, about 50 to 90° C. where the adhesive and/or sacrificial layer dissolves from the slice or wafer

What is claimed is:

1. In a process for cutting hard and brittle work-pieces in a wire cutting apparatus into thin pieces, slices, or wafers, the improvement which comprises providing said work-piece with a sacrificial layer which is adhered to said work-piece so as to prevent excessive kerf at the entry and exit points of the wire cutters.

2. The process of claim 1 wherein said sacrificial layer comprises a layer of adhesive material which is removable.

3. The process of claim 2 wherein said adhesive layer is an epoxy resin.

4. The process of claim 1 wherein said sacrificial layer comprises a tube, at least one hemisphere, or a cladding which is adhered to said work-piece.

5. The process of claim 4 wherein said sacrificial material is selected from the group consisting of glass, ceramic, polymeric, and epoxy resin.

6. The process of claim 1 wherein said sacrificial layer is about 0.1 to 3.0 inches in depth.

7. The process of claim 1 wherein the inside diameter of the sacrificial layer is about 0.5 to 3 millimeters greater than the outside diameter of said work-piece.

8. The process of claim 3 wherein said work-piece is a silicon ingot.

9. The process of claim 1 wherein said work-piece is selected from the group consisting silicon, germanium, gallium arsenide and glass.

10. The process of claim 1 including the step of removing said sacrificial layer.

11. The process of claim 1 wherein said sacrificial layer is a solid at ambient temperature and fluid at elevated temperatures.

12. The process of claim 11 wherein said sacrificial layer is a polyethylene glycol having a molecular weight greater than 600.

13. In a process for producing semiconductor chips in a wire cutting apparatus containing a lubricating composition having abrasive particles, the improvement which comprises the steps of providing a work-piece consisting of a silicon ingot having a sacrificial layer encapsulating said ingot, said sacrificial layer being about 0.1 to 3 inches in depth adhered to said ingot and cutting said ingot to prevent excessive kerf loss at the wire entry and exit points.

14. The process of claim 13 wherein said sacrificial layer is adhered to said workpiece with an adhesive.

15. The process of claim 14 wherein said adhesive is an epoxy resin.

16. The process of claim 13 wherein said sacrificial layer is an epoxy resin.

17. The process of claim 13 wherein said sacrificial layer comprises solids in a solvent soluble matrix.

18. The process of claim 13 wherein said sacrificial layer is selected from the group consisting of ceramic, glass, polymeric, and epoxy resin.

19. The process of claim 13 wherein said sacrificial layer comprises solids adhered to said work-piece from their melted state and cooled to ambient temperature.
